(19) United States
(12) Patent Application Publication
(10) Pub. No.: US 2012/0300526 A1
(43) Pub. Date: Nov. 29, 2012

(54) Power Adapter Apparatus

(76) Inventors: Ting-Ju CHUANG, Houston, TX (US); Kevin Alexander CHEN, Houston, TX (US)

(21) Appl. No.: 13/476,492

(22) Filed: May 21, 2012

Related U.S. Application Data
(60) Provisional application No. 61/519,407, filed on May 23, 2011.
(60) Provisional application No. 61/572,396, filed on Jul. 15, 2011.

(51) Int. Cl. H02M 1/00

(52) U.S. Cl. 363/146

(57) ABSTRACT

A power adapter apparatus comprises an AC power input adapted to receive AC power, an AC-to-DC converter, a switch, a timer, and a casing at least partially enclosing the AC-to-DC converter, the switch and the timer. The AC-to-DC converter is configured to convert the AC power to DC power. The switch is operable to connect the AC power input with the AC-to-DC converter, and to disconnect the AC power input from the AC-to-DC converter. The timer is operable to preset a desirable time at which the switch turns off to disconnect the AC power input from the AC-to-DC converter.

### CROSS-REFERENCE TO RELATED APPLICATION(S)

This application claims priority to U.S. Provisional Patent Application No. 61/519,407 filed on May 23, 2011; and also to U.S. Provisional Patent Application No. 61/572,396 filed on Jul. 15, 2011.

### BACKGROUND

1. Field of the Invention

The present inventions relate to power adapter apparatuses for converting AC power to DC power.

2. Description of the Related Art

The majority of electrical or electronic devices operate with connection to a power source (electrical or battery) via power cord. A common problem is that power used to operate these devices is not completely stopped from flowing to the devices. These devices normally have a switch or means to turn off or discontinue operation. But often the power is still flowing continually to the device through a power cord even though the device is switched off. For example, in case the user leaves the AC power plug plugged with the AC power outlet after the electric appliance is turned off, the transformer coils of a power adapter associated with the electric appliance may be still subject to a current flow and consume power. The ongoing flow of power through the power adapter may be minor, but it still continues to flow. As a result, energy may be wasted, which leads to loss of money. Therefore, there is a need for an apparatus that can ensure that the power flow is effectively stopped when the electric appliance is turned off.

### SUMMARY

The application describes a power adapter apparatus comprising an AC power input adapted to receive AC power, an AC-to-DC converter, a switch, a timer, and a casing at least partially enclosing the AC-to-DC converter, the switch and the timer. The AC-to-DC converter is configured to convert the AC power to DC power. The switch is operable to connect the AC power input with the AC-to-DC converter, and to disconnect the AC power input from the AC-to-DC converter. The timer is operable to preset a desirable time at which the switch turns off to disconnect the AC power input from the AC-to-DC converter.

The foregoing is a summary and shall not be construed to limit the scope of the claims. The operations and devices disclosed herein may be implemented in a number of ways, and such changes and modifications may be made without departing from this inventions and its broader aspects. Other aspects, inventive features, and advantages, as defined solely by the claims, are described in the non-limiting detailed description set forth below.

### BRIEF DESCRIPTION OF THE DRAWINGS

FIG. 1 is a block diagram illustrating an embodiment of a power adapter apparatus;

FIG. 2A is a perspective view illustrating an embodiment of a portable power adapter apparatus;

FIG. 2B is a perspective view illustrating the power adapter apparatus of FIG. 2A under a different angle of view;

FIGS. 2C and 2D are perspective views illustrating a variant embodiment of the power adapter apparatus;

FIG. 3 is a schematic view illustrating another application of the power adapter apparatus as a portable battery charger apparatus;

FIG. 4 is a block diagram illustrating another embodiment of a power adapter apparatus;

FIG. 5 is a perspective view illustrating an embodiment of a portable power adapter apparatus;

FIG. 6 is a block diagram illustrating another embodiment of a power adapter apparatus; and

FIG. 7 is a schematic view illustrating an electric appliance that can integrate a power adapter.

### DETAILED DESCRIPTION OF THE EMBODIMENTS

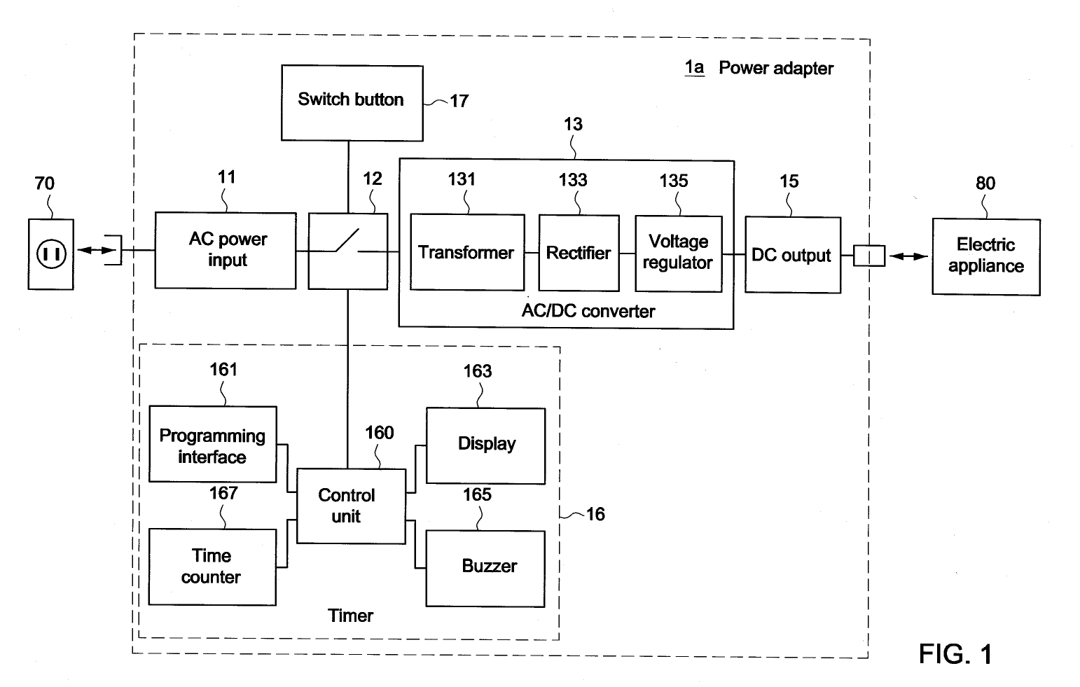

FIG. 1 is a block diagram illustrating an embodiment of a power adapter apparatus 1a. The power adapter apparatus 1a can include an AC power input 11, a switch 12, an AC-to-DC converter 13, a DC output 15, a timer 16 and a switch button 17. The power adapter apparatus 1a can receive AC power from an AC power outlet 70 via the AC power input 11, which can include an AC plug adapted to connect with the AC power outlet 70. The AC power input 11 can typically receive standard electricity from the AC power outlet 70, e.g., with a voltage of 220-240V and frequency of about 50 Hz, or with a voltage of 110V and frequency of about 60 Hz.

In one embodiment, the AC-to-DC converter 13 can include a transformer 131, a rectifier 133 and a voltage regulator 135. The AC-to-DC converter 13 can be operable to convert AC power to DC power. The DC output 15 can be connected with an output of the AC-to-DC converter 13 to deliver DC power to a host electric appliance 80.

In some embodiments, the power adapter apparatus 1a may be implemented as a portable device, and the electric appliance 80 can be any portable devices, such as laptop computers, mobile phones, smart phones, and the like. In alternate embodiments, the power adapter apparatus 1a may also be integrated within the electric appliance 80 to form an electric appliance with an embedded power adapter.

In one embodiment, the switch 12 can be a relay. The switch 12 can be electrically connected between the AC power input 11 and the AC-to-DC converter 13. More specifically, the switch 12 can have a first contact end connected with an input of the AC-to-DC converter 13, and a second contact end connected with the AC power input 11. The AC-to-DC converter 13 thereby can be electrically connected with the AC power input 11 when the switch 12 is in a conducting state (i.e., turned on), and the AC-to-DC converter 13 can be electrically disconnected from the AC power input 11 when the switch 12 is in a non-conducting state (i.e., turned off). Accordingly, the operation of the switch 12 can allow to selectively turn on and off the power adapter apparatus 1a. When the power adapter apparatus 1a is turned on, power current can flow through the AC-to-DC converter 13. When the power adapter apparatus 1a turns off, no power flows to the AC-to-DC converter 13, such that undesirable power consumption through the AC-to-DC converter 13 can be prevented.

The switch button 17 can be operatively connected with the switch 12. The switch button 17 can be actuated to turn the switch 12 from the conducting state to the non-conducting state, and from the non-conducting state to the conducting state.

The timer 16 can be operatively connected with the switch 12. The timer 16 can be operable to timely turn the switch 12 from the conducting state to the non-conducting state. In one embodiment, the timer 16 can include a control unit 160, a programming interface 161, a display 163, a buzzer 165 and a time counter 167. The programming interface 161, the display 163, the buzzer 165 and the time counter 167 can be respectively connected with the control unit 160. It is worth noting that while the control unit 160, the programming interface 161, the display 163, the buzzer 165 and the time counter 167 are described as separate blocks, several or all of these blocks may be combined into one integrated functional block.

The timer 16 can be programmed through the programming interface 161 to preset a desired time at which the control unit 160 issues a control signal to turn the switch 12 from the conducting state to the non-conducting state.

The time counter 167 can work as a clock by counting elapsed or remaining time for determining when the desired time is reached. In one embodiment, the time counter 167 can be exemplary a countdown.

The control unit 160 can control the display 163 to display information such as the programmed time value inputted through the programming interface 161, and the current time count tracked by the time counter 167. When the time count tracked by the time counter 167 reaches the programmed time value, the control unit 160 can issue a control signal to turn the switch 12 from the conducting state to the non-conducting state. In one embodiment, the control unit 160 can also activate the buzzer 165 to output a warning sound when the time count tracked by the time counter 167 reaches a predetermined value before the programmed time value. The warning signal issued by the buzzer 165 can inform the user that the switch 12 will imminently turn off.

It is worth noting that while the timer 16 and the switch 12 have been described as separate blocks for clarity of description, some embodiments can integrate the timer 16 and the switch 12 into one same block.

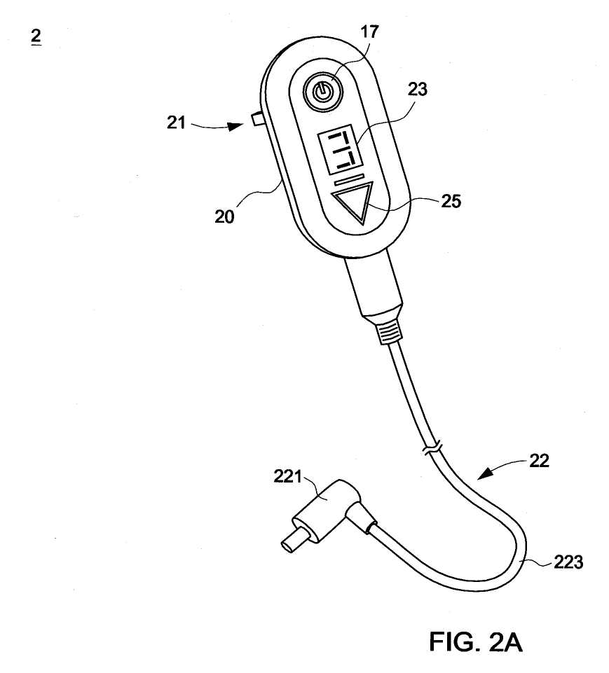

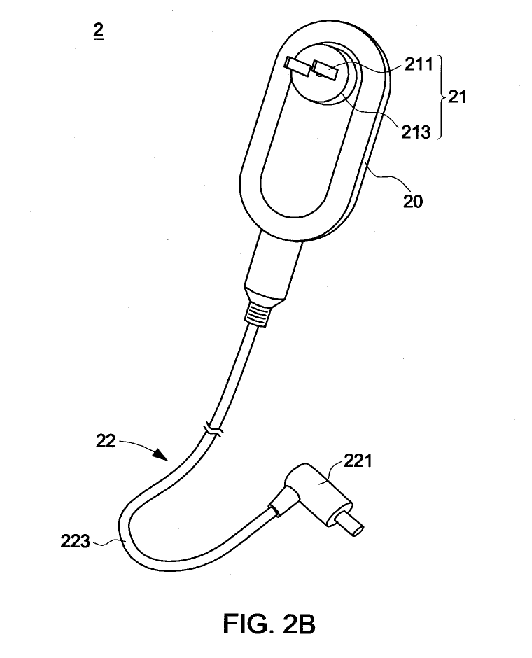

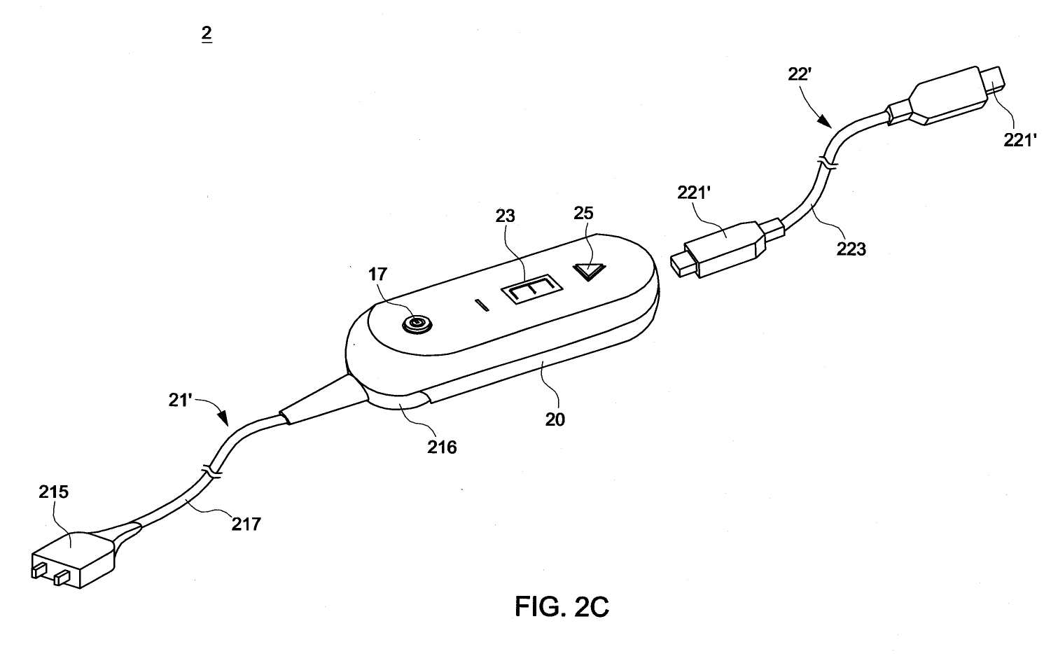

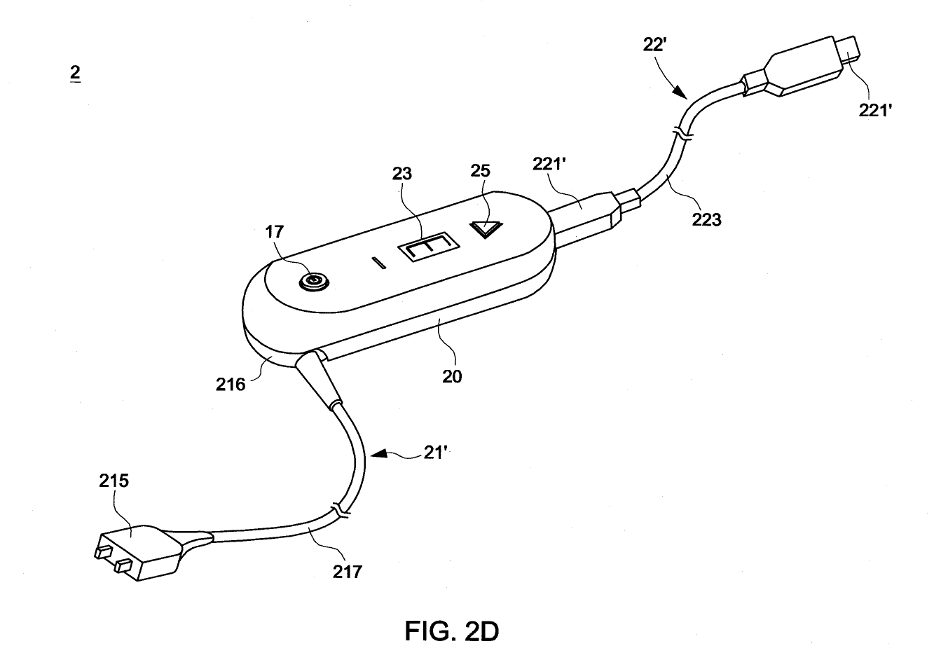

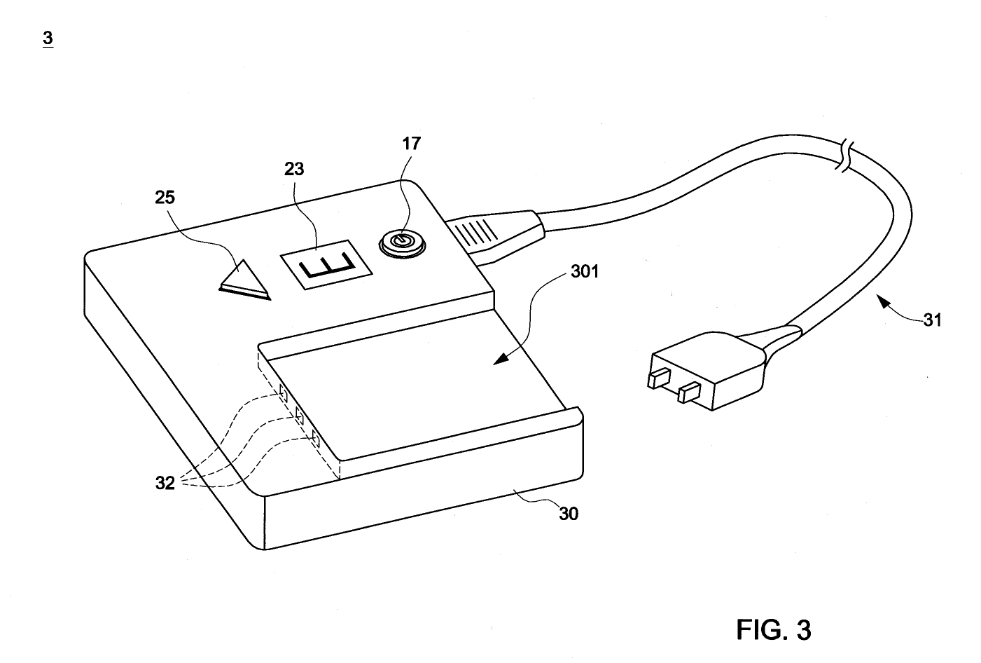

The power adapter apparatus 1a can be easily shut down by operating the switch button 17 to block the power supply to the AC-to-DC converter 13, which may otherwise continue to consume power if the AC plug of the AC power input 11 were to remain connected with the AC power outlet 70 while the electric appliance 80 is turned off in a standby mode. In case a user is worried that he/she forgets to turn off, the power adapter apparatus 1a can also be programmed to automatically shut down at a desired time. Accordingly, power consumption can be effectively saved. Examples of application of the power adapter apparatus 1a are described hereafter with reference to FIGS. 2A-2D and 3.

In conjunction with FIG. 1, FIGS. 2A and 2B are perspective views illustrating an embodiment of a portable power adapter apparatus 2. The power adapter apparatus 2 can include a casing 20, an AC power plug assembly 21, a DC output cable 22, a display screen 23, the switch button 17 and a programming key 25. The casing 20 can at least partially enclose various circuit components of the power adapter apparatus, such as the AC power input 11, the switch 12, the AC-to-DC converter 13, the DC output 15, the timer 16 and the switch button 17 shown in FIG. 1. In one embodiment, the display screen 23, the switch button 17 and the programming key 25 may be disposed close to one another so that they can be easily accessible and visible from a surface of the casing 20.

The AC power plug assembly 21 can be disposed on a first side of the casing 20, and can form a portion of the AC power input 11 shown in FIG. 1. In one embodiment, the AC power plug assembly 21 can include conductive plug prongs 211 assembled with a rotary base 213. The rotary base 213 can be pivotally connected with the casing 20. The AC power plug assembly 21 can be plugged into the AC power outlet 70 (better shown in FIG. 1) for receiving standard AC power. The rotary base 213 can allow convenient adjustment of the orientation of the casing 20 relative to the power outlet 70.

The DC output cable 22 can be connected with an end of the casing 20, and can form a portion of the DC output 15 shown in FIG. 1. The DC output cable 22 can include an end connector 221, and a DC power cord 223 respectively connected with the AC-to-DC converter 13 (shown in FIG. 1) in the casing 20 and the end connector 221. The end connector 221 can be adapted to removably connect with the electric appliance 80 for transmitting DC power to the electric appliance 80.

The programming key 25 and the switch button 17 can be provided as buttons. The programming key 25 can be connected with the programming interface 161 of the timer 16 shown in FIG. 1, and can be pressed by a user for setting a desired off-switch time at which the switch 12 is turned from the ON-state to the OFF-sate. The switch button 17 can be pressed by a user to directly turn on and turn off the switch 12.

The display screen 23 can be a liquid crystal display (LCD) device for displaying a preset time count of the timer 16. In one embodiment, the preset time count can be represented as a single-digit number of hours, e.g., three hours, five hours, or nine hours.

Once the electric appliance is turned off, a user can press on the switch button 17 to effectively stop current flowing through the power adapter apparatus 2. In alternate configurations of use, the user may also set the timer 16 by pressing on the programming key 25. The power adapter apparatus 2 then will be able to automatically shut down without the user's intervention. When the user wants to use the electric appliance, the switch button 17 can be pressed to turn the switch 12 to the ON-state and turn on the power adapter apparatus 2. Power then can be transmitted from the AC power input 11 through the switch 12 to the AC-to-DC converter 13, and then to the DC output 15. Since the power saving module comprised of the timer 16, the switch 12 and its switch button 17 are integrated with the portable power adapter, the power saving function can be always available from any sites where the electric appliance is used without the need of extra installation.

FIGS. 2C and 2D are perspective views illustrating a variant embodiment of the power adapter apparatus 2. In the embodiment shown in FIGS. 2C and 2D, the AC power plug assembly 21′ of the power saving apparatus 2 can include a plug 215, a rotary base 216 and an AC power cord 217. The rotary base 216 can be pivotally connected with the casing 20. The AC power cord 217 can be connected between the plug 215 and the rotary base 216. As shown in FIG. 2D, the rotary base 216 can be rotated relative to the casing 20 for facilitating the adjustment of the orientation of the AC power cord 217.

As shown in FIGS. 2C and 2D, one embodiment of the power adapter apparatus 2 may also be implemented as a Universal Serial Bus (USB) power adapter in which the DC output cable 22′ can be a USB cable including two USB end connectors 221′ connected at two opposite ends of the DC power cord 223. One of the USB end connectors 221′ can be removably plugged into a corresponding port in the casing 20 (as shown in FIG. 2D) to connect with the DC output of the AC-to-DC converter 13, whereas the other USB end connector 221′ can be connected with the electric appliance.

It will be readily appreciated that the power adapter apparatus described herein can be implemented with any type combinations of the AC power plug assembly and the DC output cable. For example, the AC power plug assembly 21′ may be used for the power adapter apparatus 2 shown in FIGS. 2A and 2B (i.e., substituting for the AC power plug assembly 21). The USB-type DC output cable 22′ may also replace the DC output cable 22 in the power adapter apparatus 2 shown in FIGS. 2A and 2B.

In conjunction with FIG. 1, FIG. 3 is a schematic view illustrating another application of the power adapter apparatus 1a as a portable battery charger apparatus 3. The battery charger apparatus 3 can include a casing 30 having a slot 301, an AC power plug assembly 31, DC output connector terminals 32, the switch button 17, the display screen 23 and the programming key 25. The AC power plug assembly 31 can form a portion of the AC power input 11. The casing 30 can at least partially enclose various circuit components of the battery charger apparatus 3, such as the AC power input 11, the switch 12, the AC-to-DC converter 13, the DC output 15, the timer 16 and the switch button 17 shown in FIG. 1. The slot 301 may be adapted to receive the placement of an electric appliance or battery to be electrically charged. The DC output connector terminals 32 can be arranged in the slot 301, and form a part of the DC output 15 shown in FIG. 1. Accordingly, DC power can be delivered via the DC output connector terminals 32 to the electric appliance or battery that is installed in the slot 301.

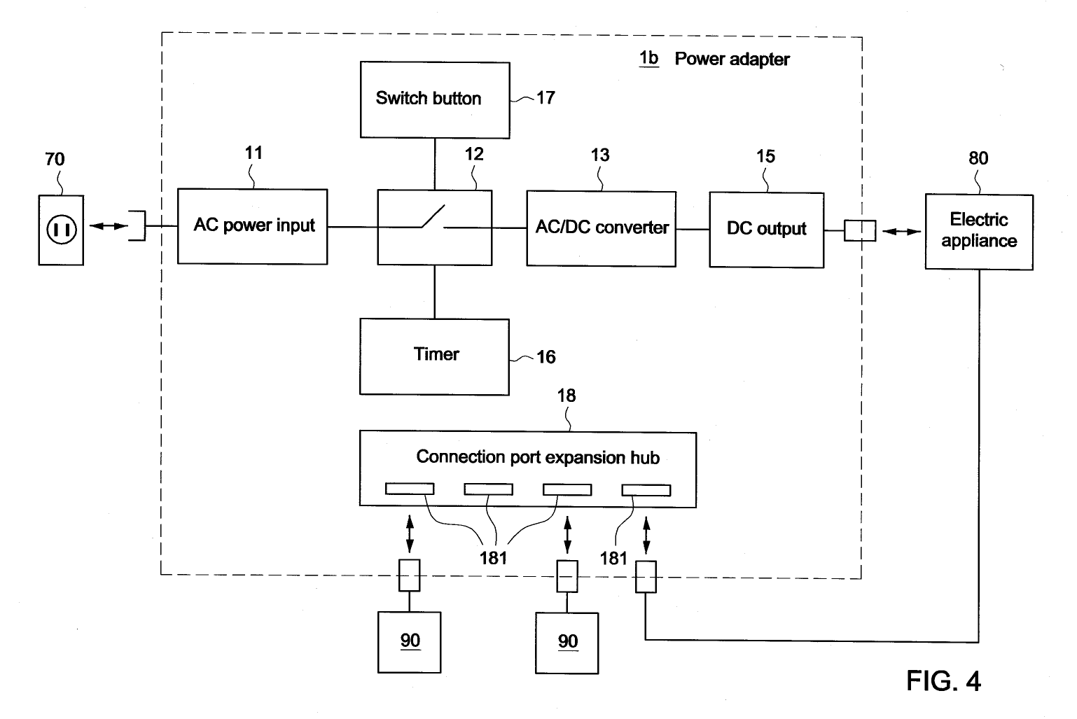

FIG. 4 is a block diagram illustrating another embodiment of a power adapter apparatus 1b. The power adapter apparatus 1b may be similar to the power adapter apparatus 1a including the AC power input 11, the switch 12, the AC-to-DC converter 13, the DC output 15, the timer 16 and the switch button 17. In addition, the power adapter apparatus 1b can include a connection port expansion hub 18 having multiple connector ports 181. In one embodiment, the connection port expansion hub 18 can be a Universal Serial Bus (USB) expansion hub including multiple USB ports. However, the expansion hub may also include other types of connection ports, such as RGB (Red, Green, Blue) output, printer port, and the like. The electric appliance 80 can connect with multiple external peripheral devices 90 via the connection port expansion hub 18 provided with the power adapter apparatus 1b.

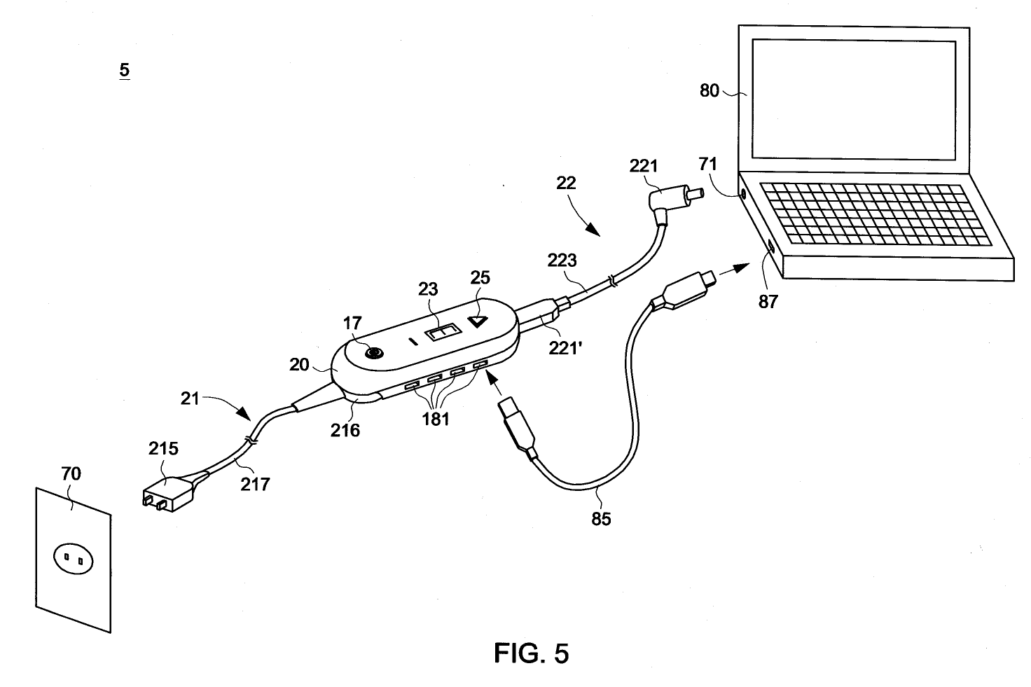

FIG. 5 is a perspective view illustrating an embodiment of a portable power adapter apparatus 5. The power adapter apparatus 5 can include the casing 20, the AC power plug assembly 21, the DC output cable 22, the display screen 23, the switch button 17 and the programming key 25. The casing 20 can at least partially enclose various circuit components of the power adapter apparatus 5, such as the AC power input 11, the switch 12, the AC-to-DC converter 13, the DC output 15, the timer 16, the switch button 17 and the connection port expansion hub 18 shown in FIG. 4. Moreover, the casing 20 can include a plurality of openings through which the connector ports 181 are exposed outward. In case the connector ports 181 are USB ports, a USB cable 85 can be used to connect one of the connector ports 181 with a USB port 87 that is internal to the electric appliance 80 and distinct from the DC power connector 71 for connecting the end connector 221. The electric appliance 80 thereby can be connected with one or more external peripheral device via the expansion hub 18 embedded with the power adapter apparatus 5. The addition of the connection port expansion hub 18 in the power adapter apparatus 5 can advantageously improve the connectivity of the electric appliance 80, without the need of bringing a separate expansion hub.

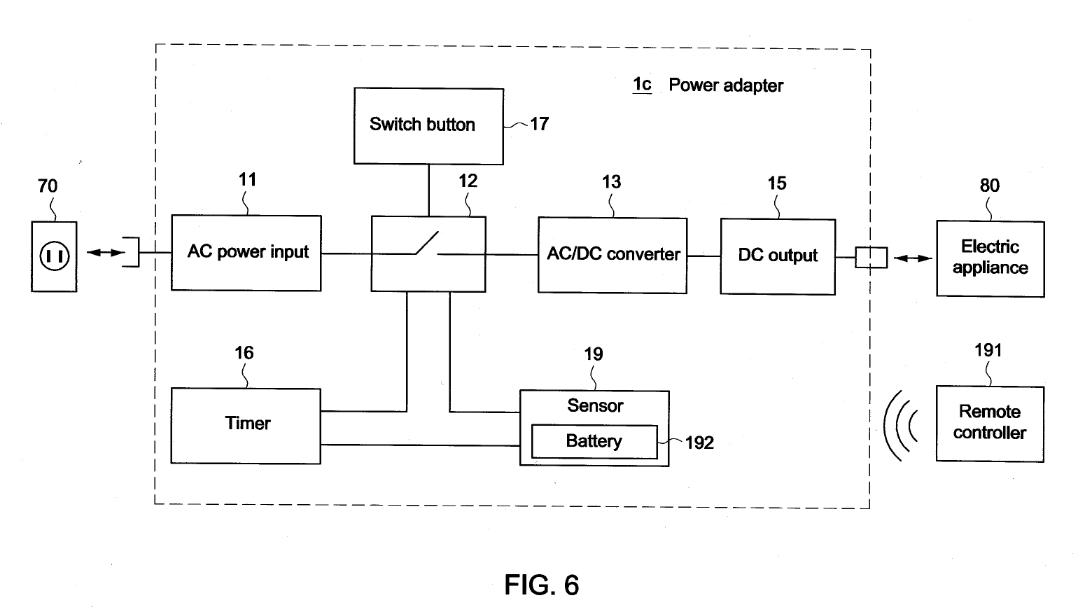

FIG. 6 is a block diagram illustrating another embodiment of a power adapter apparatus 1c. Like previously described, the power adapter apparatus 1c can include the AC power input 11, the switch 12, the AC-to-DC converter 13, the DC output 15, the timer 16 and the switch button 17. In addition, the power adapter apparatus 1c can also include a sensor 19 adapted to sense a wireless signal (e.g. infrared) emitted from a remote controller 191. The sensor 19 may be connected with the timer 16 and the switch 12, and coupled with an internal battery 192 providing necessary voltage supply for operation of the sensor 19. A user can operate the remote controller 191, which can emit a wireless signal to remotely set the timer 16 and/or turn on/off the switch 12.

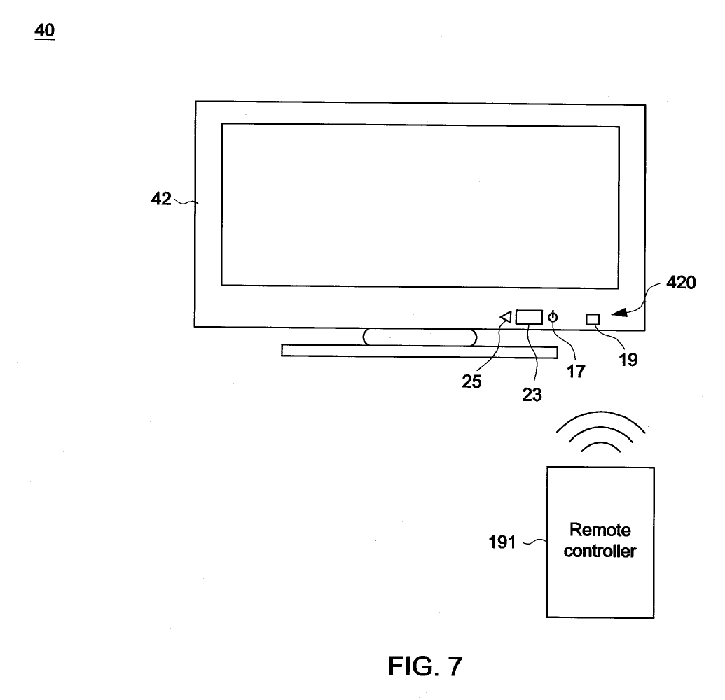

While multiple examples of the power adapter apparatus have been described as portable modules detachable from the electric appliance, the power adapter apparatus may also be integrated within the electric appliance. FIG. 7 is a schematic view illustrating an electric appliance 40 that can integrate any of the power adapters described previously. In FIG. 7, the electric appliance 40 is exemplary a television set. However, it will be readily appreciated that the electric appliance 40 can be any types of electronic products. The electric appliance 40 can have an outer housing 42 from which the switch button 17, the display screen 23 and the programming key 25 of the power adapter are visible and accessible. In case the embodiment shown in FIG. 6 is applied, the housing 42 can also have a window 420 from which the sensor 19 can sense wireless signals from the remote controller 191.

At least one advantage of the configurations described herein is the ability to provide a power adapter apparatus that can effectively save power when the electric appliance is unused and turned off. Provided with a timer, the power adapter apparatus can be programmed to turn off at a desirable time. It is worth noting that while certain of the embodiments herein depict electronic timers as examples, any types of timers may be applicable in general. For example, the power adapter apparatus may also work with a mechanical timer that can be constructed from the assembly of springs and other mechanical parts.

The foregoing realizations have been described in the context of particular embodiments. These embodiments are meant to be illustrative and not limiting. Many variations, modifications, additions, and improvements are possible. Accordingly, plural instances may be provided for components described herein as a single instance. Structures and functionality presented as discrete components in the exemplary configurations may be implemented as a combined structure or component. These and other variations, modifications, additions, and improvements may fall within the scope as defined in the claims that follow.

What is claimed is:

1. A power adapter apparatus comprising:
an alternating current (AC) power input adapted to receive AC power;
an alternating current to direct current (AC-to-DC) converter configured to convert the AC power to direct current (DC) power;
a switch operable to connect the AC-to-DC converter with the AC power input, and to disconnect the AC-to-DC converter from the AC power input;
a timer operable to preset a desirable time at which the switch turns off to disconnect the AC-to-DC converter from the AC power input; and
a casing at least partially enclosing the AC-to-DC converter, the switch and the timer.

2. The apparatus according to claim 1, further including a DC power output connected with the AC-to-DC converter to deliver the DC power to an electric appliance.

3. The apparatus according to claim 2, wherein the DC power output includes a DC output cable having an end connector adapted to removably connect with an electric appliance, and a DC power cord connected with the AC-to-DC converter and the end connector.

4. The apparatus according to claim 1, wherein the AC power input includes an AC power plug assembly.

5. The apparatus according to claim 1, further including a switch button connected with the switch, the switch button being manually operable to turn on and turn off the switch.

6. The power adapter apparatus according to claim 1, wherein the timer includes a buzzer operable to emit a warning sound indicating that the switch is about to turn off.

7. The power adapter apparatus according to claim 1, wherein the timer includes a display screen showing a preset time to turn off the switch.

8. The power adapter apparatus according to claim 1, further including a connection port expansion hub.

9. The power adapter apparatus according to claim 8, wherein the connection port expansion hub includes multiple USB ports.

10. The power adapter apparatus according to claim 1, wherein the casing has a slot adapted to receive the placement of an electric appliance or a battery to be electrically charged with the DC power.

11. A power adapter apparatus comprising:
an AC power plug assembly adapted to receive AC power;
an AC-to-DC converter configured to convert the AC power to DC power;
a switch operable to connect the AC power plug assembly with the AC-to-DC converter, and to disconnect the AC-to-DC converter from the AC power plug assembly;
a timer operable to preset a desirable time at which the switch turns off to disconnect the AC-to-DC converter from the AC power plug assembly;
a DC power cable adapted to removably connect with an electric appliance for supplying the DC power to the electric appliance; and
a casing at least partially enclosing the AC-to-DC converter, the switch and the timer.

12. The power adapter apparatus according to claim 11, further including a switch button connected with the switch, the switch button being manually operable to turn on and turn off the switch.

13. The power adapter apparatus according to claim 11, wherein the timer includes a buzzer operable to emit a warning sound indicating that the switch is about to turn off.

14. The power adapter apparatus according to claim 11, wherein the timer includes a display screen showing a preset time to turn off the switch.

15. The power adapter apparatus according to claim 11, further including a connection port expansion hub.

16. The power adapter apparatus according to claim 15, wherein the connection port expansion hub includes multiple USB ports.

17. The power adapter apparatus according to claim 11, wherein the casing has a slot adapted to receive the placement of an electric appliance or a battery to be electrically charged with the DC power.

18. The power adapter apparatus according to claim 11, further including a sensor respectively connected with the switch and the timer, wherein the sensor is configured to sense a wireless signal emitted from a remote controller to operate the switch or preset the timer.

19. An electric appliance comprising:
an AC power plug assembly adapted to receive AC power;
an AC-to-DC converter configured to convert the AC power to DC power;
a switch operable to connect the AC power plug assembly with the AC-to-DC converter, and to disconnect the AC-to-DC converter from the AC power plug assembly;
a timer operable to preset a desirable time at which the switch turns off to disconnect the AC-to-DC converter from the AC power plug assembly; and
a housing at least partially enclosing the AC-to-DC converter, the switch and the timer.

20. The electric appliance according to claim 19, further including a switch button connected with the switch, the switch button being manually operable to turn on and turn off the switch.
